(19) United States
(12) Patent Application Publication
(10) Pub. No.: US 2014/0050105 A1
(43) Pub. Date: Feb. 20, 2014

(54) Traffic-Adaptive Repeated Transmission

(71) Applicant: FUTUREWEI TECHNOLOGIES, INC., Plano, TX (US)

(72) Inventors: Ruxiang Wang, San Jose, CA (US); Yan Zhang, Shenzhen (CN); Guozhu Long, Fremont, CA (US); Dong Wei, Austin, TX (US)

(73) Assignee: FUTUREWEI TECHNOLOGIES, INC., Plano, TX (US)

(21) Appl. No.: 13/682,842

(22) Filed: Nov. 21, 2012

Related U.S. Application Data
(60) Provisional application No. 61/683,329, filed on Aug. 15, 2012.

(51) Int. Cl. H04L 29/06

(52) U.S. Cl. CPC H04L 69/166; H04L 43/0888
USPC 370/252; 370/468

(57) ABSTRACT

An apparatus used for digital subscriber line (DSL) communication comprising a processor configured to generate a data transmission unit (DTU) comprising user data and a transmitter configured to repeatedly transmit the DTU a plurality of times onto a subscriber line, wherein a number of the plurality of times is adaptively based on a user data rate of the subscriber line. A method of data communication comprising generating a DTU comprising user data and repeatedly transmitting the DTU a plurality of times onto a subscriber line, wherein a number of the plurality of times is adaptively based on a data rate of the subscriber line.

### CROSS-REFERENCE TO RELATED APPLICATIONS

The present application claims priority to U.S. Provisional Patent Application No. 61/683,329 filed Aug. 15, 2012 by Ruxiang Wang, et al. and entitled “Traffic-Adaptive Repeated Transmission”, which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Modern digital subscriber line (DSL) communication systems may provide impulse noise protection (INP) by using, for example, retransmission schemes. In retransmission, data transmitted over subscriber line may be stored at the transmitting site for some time. In case the receiving side receives corrupt data, the transmitting side may retransmit the data for an additional time. Retransmission may be triggered by a retransmission request sent from the receiving side. In some instances, current noise protection techniques may not provide sufficient protection for high-quality services, such as internet protocol television (IPTV) or video services, since noise disturbances may be strong for these services.

Current DSL systems may have fixed connection rates. When an actual user data rate of a subscriber line is lower than its connection rate, a DSL transmitter may add idle cells to keep a constant physical media dependent (PMD) transmitting rate. Idle cells may take up bandwidth with little if any benefit to system performance. Whether a data transmission unit (DTU) (sometimes also referred to as a data transfer unit) is user data or just idle cells, when a receiver detects error or corruption, it may request retransmission. When the user data rate is low, potentially many idle cells may be inserted into a DTU, consequently bandwidth may be wasted on processing the idle cells. For example, in a DSL system, in case a discontinuous transmission mode is not utilized or not supported, idle cells or idle DTUs may be added to maintain a constant transmission frequency of discrete multi-tone (DMT) symbols.

### SUMMARY

In one embodiment, the disclosure includes an apparatus used for DSL communication comprising a processor configured to generate a DTU comprising user data and a transmitter configured to repeatedly transmit the DTU a plurality of times onto a subscriber line, wherein a number of the plurality of times is adaptively based on a user data rate of the subscriber line.

In another embodiment, the disclosure includes a method of data communication comprising generating a DTU comprising user data and repeatedly transmitting the DTU a plurality of times onto a subscriber line, wherein a number of the plurality of times is adaptively based on a data rate of the subscriber line.

In yet another embodiment, the disclosure includes an apparatus used in a DSL system and coupled to a subscriber line, wherein the apparatus comprises a processor configured to generate a DTU comprising at least one user data codeword and determine a number of transmissions of the DTU based on a data rate of the subscriber line, wherein the number of transmissions is greater than one, a transmitter configured to transmit the DTU for the number of transmissions, and a receiver configured to receive a response corresponding to each time of transmitting the DTU, wherein each response comprises an acknowledgement (ACK) or a negative acknowledgment (NACK), and wherein the processor is further configured to instruct the transmitter to transmit the DTU an additional time only if all responses comprises NACKs.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a DSL system.

FIG. 2 is a schematic diagram of an embodiment of an apparatus reference model.

FIG. 3 is a schematic diagram of an exemplary comparison of a conventional transmission scheme with embodiments of repeated transmission schemes.

FIG. 4 is a schematic diagram of another exemplary comparison of a conventional transmission scheme with embodiments of repeated transmission schemes.

FIG. 5 is a flowchart of an embodiment of a number of repeated DTU (NRD) updating method.

FIG. 6 is a flowchart of an embodiment of a repeated transmission method.

FIG. 7 is a flowchart of an embodiment of a retransmission method.

FIG. 8 is a flowchart of another embodiment of a retransmission method.

FIG. 9 is a schematic diagram of an embodiment of a DSL modem.

FIG. 10 is a schematic diagram of an embodiment of a general-purpose computer system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents. While certain aspects of conventional technologies have been discussed to facilitate the present disclosure, applicants in no way disclaim these technical aspects, and it is contemplated that the present disclosure may encompass one or more of the conventional technical aspects discussed herein.

Disclosed herein are systems and methods to improve performance of DSL systems, such as asymmetric DSL (ADSL), very high speed DSL (VDSL), and G.fast systems, by utilizing redundant bandwidth when a user data rate is lower than a connection rate. In an embodiment, a DTU comprising user data may be repeatedly transmitted a plurality of times from a transmitting side, and a number of plurality of times may be determined adaptively based on the user data rate. By repeatedly transmitting the DTU comprising user data, the transmission of idle DTUs containing no user data is reduced or eliminated. The repeated transmission of the DTU may not need to wait for a retransmission request from a corresponding receiving side. As a result, the receiving side may have a higher chance to receive an error-free version of the DTU. Thus, the likelihood that the receiving side needs to request retransmission of the DTU is reduced, and the DTU may not need to be retransmitted an additional time. In other words, the traffic adaptive repeated transmission (TARTX) schemes disclosed herein may take advantage of redundant bandwidth to improve noise protection and/or reduce retransmission delay.

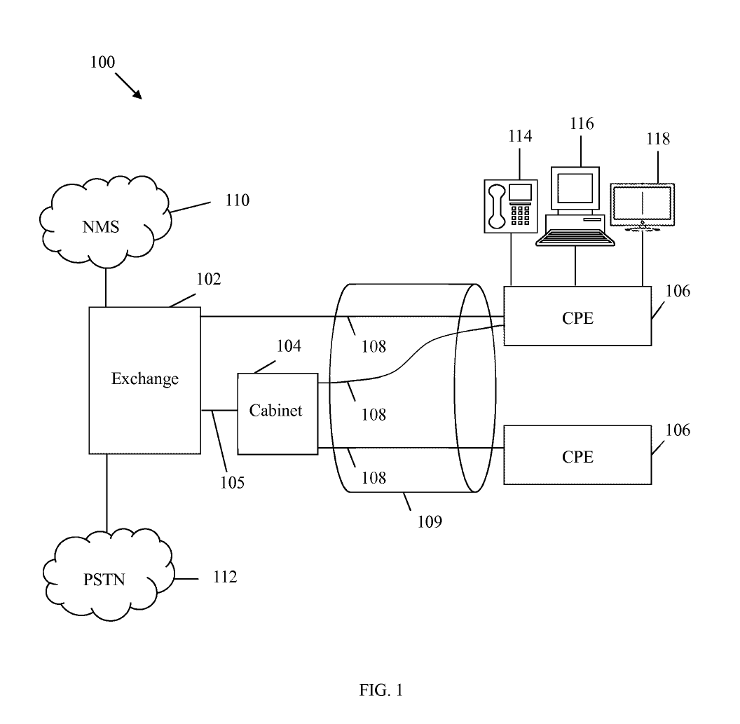

FIG. 1 is a schematic diagram of an embodiment of a DSL system 100, wherein embodiments of the present disclosure may operate. The DSL system 100 may be an ADSL2 system, an ADSL2+ system, a VDSL2 system, or any other DSL system (e.g., systems being defined by the International Telecommunication Union Telecommunication Standardization Sector (ITU-T) G.hn or G.fast standards). The DSL system 100 may comprise an exchange 102, a cabinet 104 coupled to the exchange 102 by a cable 105, and a plurality of customer premises equipment (CPEs) 106, which may be coupled to the exchange 102 and/or the cabinet 104 via a plurality of subscriber lines 108. The subscriber lines 108 may be made of any suitable material such as copper wire or optical fiber. At least some of the subscriber lines 108 may be bundled in a binder 109. Additionally, the DSL system 100 may optionally comprise a network management system (NMS) 110 and a public switched telephone network (PSTN) 112, both of which may be coupled to the exchange 102. In other embodiments, the DSL system 100 may be modified to include splitters, filters, management entities, and various other hardware, software, and functionality.

The NMS 110 may be a network management infrastructure that processes data exchanged with the exchange 102 and may be coupled to one or more broadband networks, such as the Internet. The PSTN 112 may be a network that generates, processes, and receives voice or other voice-band signals. In an embodiment, the exchange 102 may be a server located at a central office (CO) and may comprise switches and/or splitters, which may couple the NMS 110, the PSTN 112, and the subscriber lines 108. For instance, the splitter may be a 2:1 coupler that forwards data signals received from the subscriber lines 108 to the NMS 110 and the PSTN 112, and forwards data signals received from the NMS 110 and the PSTN 112 to the subscriber lines 108. Further, the splitter may optionally comprise one or more filters to help direct data signals between the NMS 110, the PSTN 112, and the subscriber lines 108. Additionally, the exchange 102 may comprise at least one DSL transmitter/receiver (transceiver), which may exchange signals between the NMS 110, the PSTN 112, and the subscriber lines 108. The signals may be received and transmitted using the DSL transceiver such as a modem. In an embodiment, the DSL transceiver may comprise a forward error correction (FEC) codeword generator that generates FEC data, an interleaver that interleaves the transmitted data across a plurality of sub-carriers, or both. For instance, the DSL transceiver may use a discrete multi-tone (DMT) line code that allocates a plurality of bits for each sub-carrier or tone in each symbol. The DMT may be adjusted to various channel conditions that may occur at each end of a subscriber line. In an embodiment, the DSL transceiver of the exchange 102 may be configured to transmit data at similar or different rates for each subscriber line 108.

In an embodiment, the cabinet 104 may be located at a distribution center between the CO and customer premises and may comprise switches and/or splitters, which may couple the exchange 102 to the CPEs 106. For instance, the cabinet 104 may comprise a DSL access multiplexer (DSLAM) that couples the exchange 102 to the CPEs 106. Additionally, the cabinet 104 may comprise one or more DSL transceivers, which may be used to exchange signals between the exchange 102 and the CPEs 106. The one or more DSL transceivers may process the received signals or may simply pass the received signals between the CPEs 106 and the exchange 102. The splitter in the cabinet 104 may be a N:1 coupler (where N is an integer) that routes data signals received from the exchange 102 to N CPEs 106, and routes data signals received from the N CPEs 106 to the exchange 102. The data signals may be transmitted and received using the DSL transceiver. Further, the splitter of the cabinet 104 may optionally comprise one or more filters to help direct data signals between the exchange 102 and the CPEs 106 via the corresponding subscriber lines 108. In an embodiment, the DSL transceiver may be configured to transmit data to the CPEs 106 at similar or different rates and/or power for each subscriber line 108. The cabinet 104 may also be referred to as a remote terminal (RT). In implementation, the exchange 102 (or the cabinet 104) may comprise a plurality of transceivers, and a central management entity (e.g., a processor) located in the exchange 102 (or the cabinet 104) may be configured to manage the plurality of transceivers, e.g., by controlling their transmission/receiving modes.

Depending on the supported standard, the DSL system 100 may be referred to as an xDSL system, where ‘x’ may indicate a DSL standard. For instance, ‘x’ stands for ‘A’ in ADSL2 or ADSL2+ systems, and ‘x’ stands for ‘V’ in VDSL or VDSL2 systems. When a transceiver in the DSL system 100 is located in a CO, the transceiver may be referred to as an xTU-C. In practice, as long as the transceiver is located at an operator end of the DSL system or loop (including a CO, exchange, or cabinet), it may be referred to as an xTU-C. On the other hand, when a transceiver in the DSL system 100 is located at a remote or user end such as a customer premise, the transceiver may be referred to as an xTU-R. For example, if the DSL system 100 is a VDSL2 system, a CO transceiver may then be referred to as a VDSL2 transceiver unit (VTU) at an optical network unit (VTU-O). The term VTU-O is sometimes also referred to as a VTU at a central office (VTU-C). In the VDSL2 system, a CPE transceiver may be referred to as a VTU at a remote terminal (VTU-R).

In an embodiment, the CPEs 106 may be located at the customer premises, where at least some of the CPEs 106 may be coupled to a telephone 114, a computer 116, and/or a television 118. The telephone 114 may be hardware, software, firmware, or combinations thereof that generates, processes, and receives voice or other voice-band signals. The CPE 106 may comprise a switch and/or a splitter, which may couple the subscriber lines 108 and the telephone 114, the computer 116, and the television 118. The CPE 106 may also comprise a DSL transceiver to exchange data between the CPE 106 and the exchange 102 via the subscriber line 108. For instance, the splitter may be a 2:1 coupler that forwards data signals received from the subscriber line 108 to the telephone 114 and the DSL transceiver, and forwards data signals received from the telephone 114 and the DSL transceiver to the subscriber line 108. The splitter may optionally comprise one or more filters to help direct data signals to and from the telephone 114 and the DSL transceiver. The DSL transceiver (e.g., a modem), may transmit and receive signals through the subscriber lines 108. For instance, the DSL transceiver may process the received signals to obtain the transmitted data from the exchange 102, and pass the received data to any of the telephone 114, the computer 116, and the television 118. The CPEs 106 may be coupled to the exchange 102 directly via the subscriber lines 108 and/or via the subscriber lines 108 and the cabinet 104. For example, any of the CPEs 106 may be coupled to a subscriber line 108 from the exchange 102 and/or a subscriber line 108 from the cabinet 104. The CPEs 106 may access the NMS 110, the PSTN 112, and/or other coupled networks via the subscriber lines 108 deployed by the exchange 102 and/or the cabinet 104.

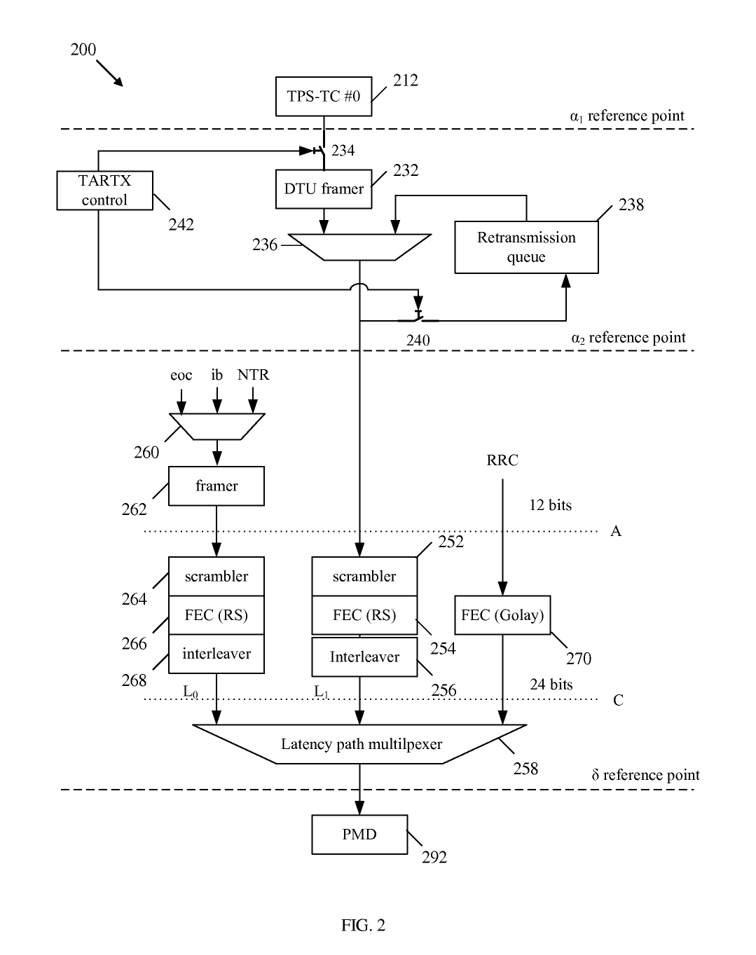

FIG. 2 illustrates an embodiment of a reference model 200 of an apparatus, which may be implemented in the DSL system 100 (e.g., as part of the exchange 102, the cabinet 104, and/or the CPEs 106). The reference model 200 may correspond to a physical (PHY) layer and may be grouped or classified into several sublayers, which are separated by reference points. For example, the sublayers may include a transport protocol specific-transmission convergence (TPS-TC) sublayer, a traffic adaptive repeated transmission (TARTX) sublayer coupled to the TPS-TC sublayer via an α₁ reference point, a physical media specific-transmission convergence (PMS-TC) sublayer coupled to the TARTX sublayer via an α₂ reference point, and a physical media dependent (PMD) sublayer coupled to the PMS-TC sublayer via a δ reference point. Such sublayers may be included in CO and/or CPE transceivers. Further, sublayer structures may vary depending on the application. For example, if desired, the TARTX sublayer may be considered or defined as part of the PMS-TC sublayer.

In the reference model 200, the TPS-TC sublayer may comprise a TPS-TC module 212. In a downstream direction, the TPS-TC module 212 may use a bearer channel (#0). The TPS-TC module 212 may receive user data from a network source (e.g., the Internet) and process the user data using a TPS-TC function. Various types of TPS-TC functions may be used in the TPS-TC module 212, including, but not limited to, synchronous transfer mode (STM), asynchronous transfer mode (ATM), and packet transfer mode (PTM). After processing, the user data may be assembled or packed into one or more DTUs, which may then be forwarded to a DTU framer 232. The DTU framer 232 may be located in the TARTX sublayer and coupled to the TPS-TC module 212 via a logical or physical switch 234. The switch 234 is shown for illustrative purposes and may indicate allowance or denial of an action. The DTU framer 232 may further process the DTU (e.g., adding other information). Depending on the type of TPS-TC function implemented in the TPS-TC module 212, each DTU generated by the TPS-TC module 212 may comprise a plurality of AMT cells, a plurality of PTM codewords, or a plurality of Reed Solomon (RS) codewords. Further, after the DTU framer 232, each DTU may comprise additional octets carrying information such as a sequence identifier (SID), a time stamp (TS), overhead for a cyclic redundancy check (CRC), and padding bytes.

DTUs processed by the DTU framer 232 may be fed into a retransmission multiplexer 236. In an embodiment, the retransmission multiplexer 236 may select either a DTU from the DTU framer 232 or a DTU from a retransmission queue 238 for transmission over the α₂ reference point. The retransmission queue 238 is coupled to the retransmission multiplexer 236 via a logical or physical switch 240. In an embodiment, the switches 234 and 240 are controlled by a TARTX control unit 242, which may take the form of a processor (e.g., any general processor). The switches 234 and 240 may be implemented using software and/or hardware. In an embodiment, the TARTX control unit 242 may be configured to control transmission by opening the switch 234, thus no new user data may be obtained from the TPS-TC module 212. When the switch 234 is open, a DTU in the DTU framer 232 may be repeatedly transmitted a plurality of times, a number of which may be denoted herein as NRD. In an embodiment, NRD may be determined adaptively based on a data rate of the subscriber line. After the DTU is transmitted for NRD times, the TARTX control unit 242 may then close the switch 234. If any new user data has become available in the TPS-TC module 212, the new user data may then be packed into one or more new DTUs and transmitted. Otherwise, if no new user data is available in the TPS-TC module 212, one or more idle DTUs (IDTUs), each of which comprising entirely idle cells, may be transmitted until new user data arrives at the TPS-TC module 212. Alternatively, the current DTU may be transmitted more times until new user data arrives.

In an embodiment, when the current DTU is transmitted for a first time of the NRD times, the TARTX control unit 242 may be configured to close the switch 240, so that a copy of the current DTU may be added to or stored in the retransmission queue 238, which may reside in a memory. Then, when the current DTU is repeatedly transmitted for “NRD-1” times, the TARTX control unit 242 may be configured to open the switch 240, so that the current DTU may not be repeatedly added to the retransmission queue 238. Alternatively, if desired, multiple copies of the current DTU can be added to the retransmission queue 238. Similarly, when a new DTU is generated by the TPS-TC module 212 and transmitted for the first time, the switch 240 may be closed, so that a copy of the new DTU can be added to the retransmission queue 238.

In an embodiment, the reference model 200 may be configured to differentiate an IDTU from a non-idle DTU (NIDTU, i.e., DTU comprising user data). For example, in a certain time slot, the amount of user data (e.g., a number of user codewords or cells) may be counted in the TPS-TC module 212 using a counter or register. If the count is zero, it may suggest that no user data has arrived, thus any DTU generated by the TPS-TC module 212 will be IDTUs. In this case, instead of transmitting IDTUs which waste bandwidth, the previous DTU that was being transmitted may continue to be transmitted more times until the count becomes one or more. This may be realized by, for example, keeping the switch 234 open. As a result, no IDTUs may be added to the retransmission queue 238, which saves storage space. Further, by discarding IDTUs, the robustness of NIDTU in the DTU framer 232 may be improved because the NIDTU may be transmitted more times. In addition, a next NIDTU may be transmitted earlier, since it may not need to wait for IDTU transmission.

After a DTU is added into the retransmission queue 238, it may be kept in the queue for a period of time. A duration of the period may be pre-determined e.g., to be 5 milliseconds. The period of time should be sufficiently long to determine whether all repeated transmissions of the DTU were corrupted when propagating in the subscriber line. If a corresponding apparatus, which is a recipient of the DTU, detects error or corruption in the DTU, it may send a NACK to the reference model 200. In an embodiment, since the DTU is transmitted to the recipient for NRD times, the reference model 200 is configured to retransmit the DTU only if the DTU is corrupted in all repeated transmissions. If retransmission is activated, the DTU may be located in the retransmission queue 238, e.g., based on its SID, and then transmitted for an additional time. If an ACK is received by the reference model 200 corresponding to the additional transmission of the DTU, the ACK indicates that the DTU was received by a CPE without error, in which case the DTU may be removed from the retransmission queue 238. Otherwise, the DTU may remain in the retransmission queue until an ACK is received, or until its storing period is reached. Furthermore, retransmission may be enabled in upstream and/or downstream directions.

During transmission of a DTU, the retransmission multiplexer 236 may feed the DTU into a scrambler module or unit 252. The DTU may then go through error correction in a forward error correction (FEC) unit 254, which may use RS coding. Then, the DTU may be processed by an interleaver 256. Afterwards, the DTU may be fed into a latency path multiplexer 258, which combines data from multiple paths and/or channels. The PMS-TC sublayer may comprise two latency paths, denoted as L₀ and L₁ respectively, and a retransmission request channel (RRC). The latency path 0 may contain only overhead data, while the latency path 1 may contain DTUs (i.e., octets coming over the α2-reference point).

In the latency path 0, overhead information, including an embedded operations channel (eoc), an indicator bit (ib), and a network time reference (NTR), may be combined by an overhead multiplexer 260. Then, the overhead may be framed by a framer 262, which feeds into a scrambler unit 264. The scrambler unit 264 is coupled to a FEC unit 266, which is also coupled to an interleaver 268.

On the other hand, the RRC may carry an ACK or a NACK for received DTUs. In addition, the RRC may be encoded in an FEC unit 270, which uses an extended binary Golay code. The output from the two latency paths and the RRC are multiplexed by the latency path multiplexer 258 into a data structure that is transferred to the PMD module 292 over the δ-reference point. After being processed by the PMD module 292, the DTU may be sent out of the reference model 200 as, e.g., digital multi-tone (DMT) symbols.

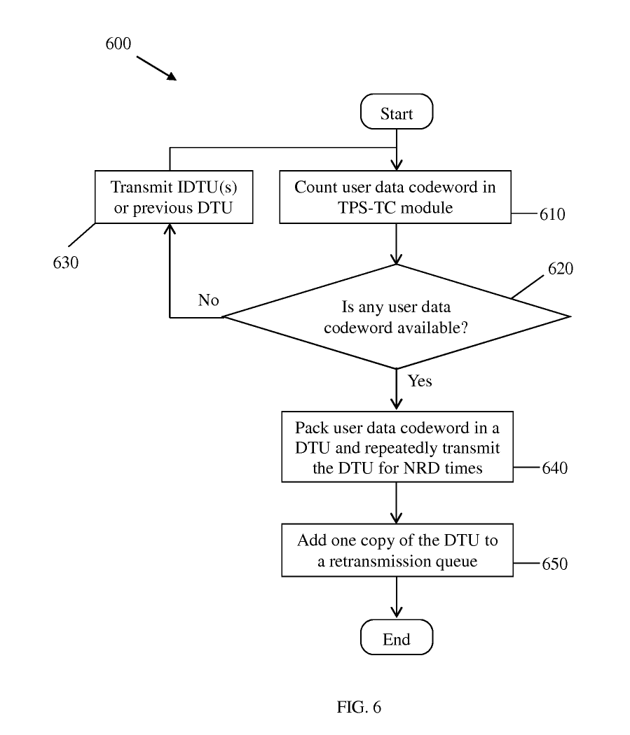

The reference model 200 may be similar to a conventional reference model, such as the reference model shown in FIG. 6-1 of the ITU-T G.998.4 Recommendation entitled “Improved Impulse Noise Protection (INP) for DSL Transceivers”, which is incorporated herein by reference. Compared with the conventional reference model, the TARTX control unit 242 and the switches 234 and 240 are additional modules/units to facilitate implementing embodiments of this disclosure. It should be noted that the modules illustrated in FIG. 2 may only include a portion of all necessary modules in a DSL transmitter. Accordingly, other modules or units, such as transmitter, receiver, analog front end, line driver, etc., may be incorporated into the reference model 200 wherever appropriate.

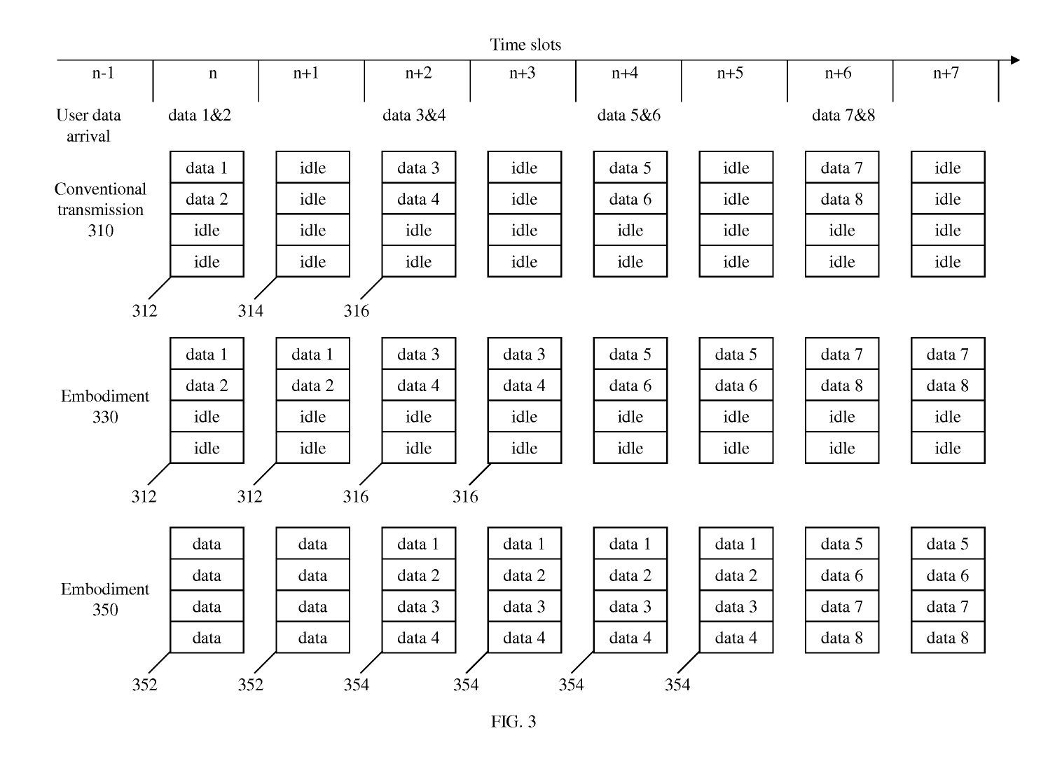

FIG. 3 illustrates an exemplary comparison of a conventional transmission scheme with embodiments of repeated transmission schemes disclosed herein. As mentioned above, each DTU may comprise an integer number of cells or codewords. Take codeword as an example, with the premise that other formats of DTUs can be similarly implemented without departing from the scope of the present disclosure. Each DTU may comprise a pre-determined or fixed number of codewords, and each codeword may be a user data codeword or an idle codeword. A user data codeword carries data requested by a user of the DSL system, while an idle codeword may be empty or carry random data. Each codeword may have any appropriate size, e.g., comprising a 65-octet PTM codeword.

User data may arrive at the TPS-TC sublayer in any pattern (e.g., can be regular, random, or unpredictable), and then encapsulated into DTUs as user data codewords for transmission. Each DTU may be transmitted over a period of time, which may be referred to as a time slot. In use, a duration of the time slot may be fixed to maintain a consistent frequency of DTU transmission (e.g., number of DTUs transmitted per second). When a user data rate of the subscriber line is high, e.g., equal to a connection rate (or line rate) of the subscriber line, the subscriber line may be operating at full capacity, thus no idle codewords or idle DTUs may be transmitted. On the other hand, when the user data rate is lower than the line rate, embodiments of the present disclosure may implement different transmission schemes from a conventional scheme. For illustrative purposes, suppose that user data that can be encapsulated into two user data codewords may arrive at the transmitting apparatus (e.g., the reference model 200 in FIG. 2) in every other time slot, as shown in FIG. 3. Eight consecutive time slots, denoted as n, n+1, . . . , n+7, are shown in this example, where n is an integer. In the interest of conciseness, each user data codeword is illustrated simply as “data k”, where k is an integer (with values of 1 to 8 in this example), while each idle codeword is illustrated simply as “idle”.

In a conventional transmission scheme 310, user data accumulated in the TPS-TC sublayer may be transmitted once immediately. When the data rate is lower than the connection rate, user data may only fill part of the codeword spaces in a DTU. For example, data 1 and data 2 received in time slot n only fill two of the four codeword spaces in a DTU 312. In this case, two idle codewords are inserted into the remaining spaces of the DTU 312, which is then transmitted. In time slot n+1, there may be no user data available, thus an idle DTU 314 may be transmitted, so that a consistent frequency of DTU transmission may be maintained. If the user data arrival pattern remains the same in following time slots (which is the case in FIG. 3), the transmission pattern remains the same. That is, each DTU comprising two user data codewords is followed by an IDTU.

An embodiment of a repeated transmission scheme 330 may be used when the data rate is lower than the connection rate. Suppose that the user data arrival pattern remains the same. In this embodiment, after transmitting the DTU 312 in time slot n, the DTU 312 may be transmitted again in time slot n+1. In this case, the number of repeated transmission, denoted as NRD, is configured to be two. The repeated transmission of the DTU 312 is different from the conventional scheme, which transmits the IDU 314 in time slot n+1. In the following time slots, the transmission pattern remains the same. That is, each DTU is repeatedly transmitted twice.

An alternative embodiment of a repeated transmission scheme 350 may be used. Suppose that the user data arrival pattern remains the same. In this embodiment, a DTU may not be transmitted until all of its codeword spaces are filled or occupied by user data codewords. For example, in time slots n and n+1, since data 1 and data 2 can not fully fill up any DTU, a DTU 352 fully occupied by previously arrived user data may be repeatedly transmitted (e.g., for four times from slots n−2 to n+1). Then, in time slot n+2, data 1, data 2, data 3, and data 4 have become available, which may fully fill up a DTU 354. Thus, the DTU 354 may be repeatedly transmitted for four times from slots n+2 to n+5. In the following time slots, the transmission pattern remains the same. That is, each DTU is repeatedly transmitted four times.

Although four codeword spaces are included in each DTU, as shown in FIG. 3, it should be understood that each DTU may have any suitable number of codewords or cells. Although two user data codewords are received in every other time slot in this example, any other number of user data codewords may be received in each time slot. For example, one user data codeword may be received in every other time slot, in which case a similar scheme of repeated transmission may be implemented.

In practice, since user data may arrive in a TPS-TC sublayer unevenly, each DTU carrying user data may comprise any number of user data codewords. For example, although a DTU 316 and the DTU 312 are illustrated as both having two user data codewords, these two DTUs may have a different number of user data codewords. For instance, the DTU 316 may have three user data codewords (data 3, 4, and 5) and one idle codeword. In this case, the DTU 316 may still be transmitted twice in time slots n+2 and n+3, according to the repeated transmission scheme 330. Accord to the repeated transmission scheme 350, the first four user data codewords may be repeatedly transmitted first, while the fifth user data codeword may be held until a new DTU can be completely filled again.

Although each DTU is transmitted only twice, as shown in the embodiment 330 in FIG. 3, it should be understood that each DTU may be transmitted three or more times. The value of NRD may depend on the data rate of the subscriber line. If the user data arrival pattern remains as shown in FIG. 3, while NRD has previously been configured to be three or more, there may be delay of user data in the TPS-TC module. The delay may be insignificant and temporary, since NRD may be updated periodically based on the data rate. On the other hand, if NRD is less than a gap between user data arrival, one or more IDTUs may still be transmitted according to embodiments. For example, if one user data codeword is available in every five time slots while NRD=3, each DTU comprising one user data codeword may be transmitted for three times, followed by two IDTUs.

Although each DTU is transmitted for an equal number of times in embodiments 330 and 350, as shown in FIG. 3, it should be understood that, if NRD is changed during the time slots n to n+7, each DTU may be transmitted for a different number of times. For example, if the user arrival pattern changes during time slot n+4 (from two data codewords in every other time slot to one data codeword in every ten time slots), NRD may be updated from two to ten, and DTUs transmitted in and after time slot n+4 may be changed accordingly.

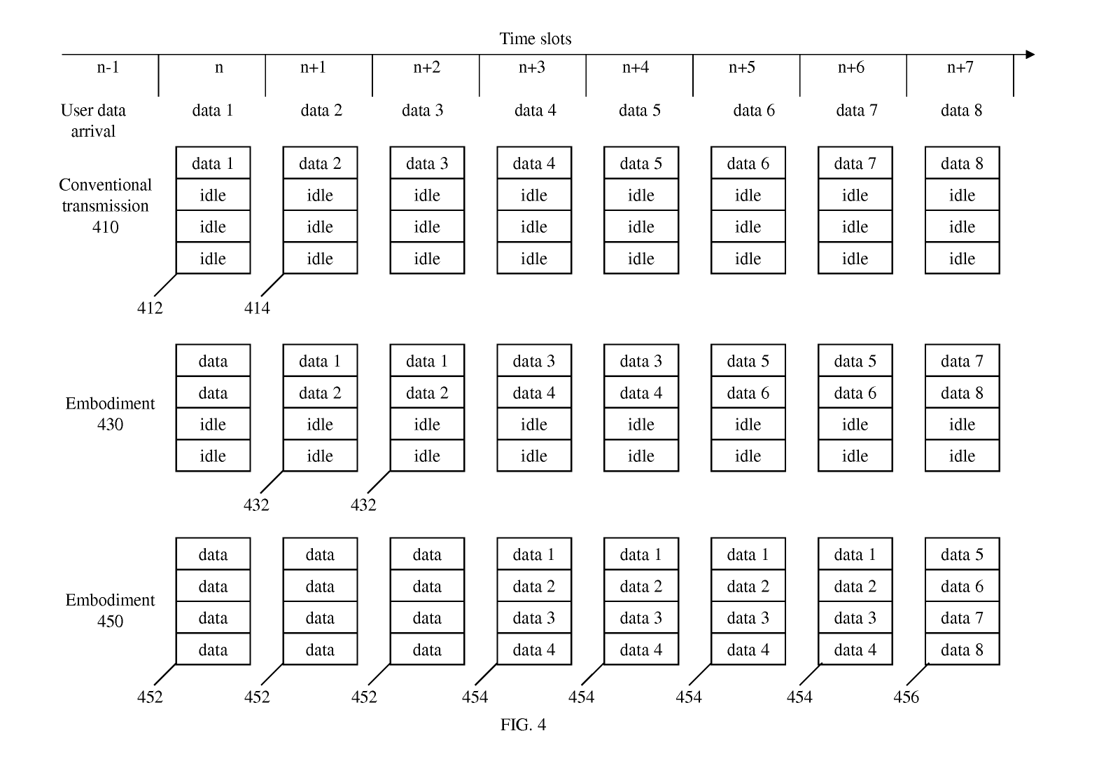

FIG. 4 illustrates another exemplary comparison of a conventional transmission scheme with embodiments of repeated transmission schemes. Since various aspects of the FIG. 4 are similar to the FIG. 3, in the interest of conciseness, mainly different aspects will be further described. As mentioned above, user data may arrive in various patterns, in this case having one user data codeword available in each time slot. A conventional transmission scheme 410 is similar to the conventional transmission scheme 310. Specifically, a DTU 412 comprising data 1 is transmitted in time slot n, a DTU 414 comprising data 2 is transmitted in time slot n+1, and so forth.

An embodiment of a repeated transmission scheme 430 may be used when the data rate is lower than the connection rate. Suppose that the user data arrival pattern remains the same. In this embodiment, each two user data codewords received in two time slots are combined or stacked into one DTU, which is then transmitted twice. For example, data 1 and data 2 are combined into a DTU 432 and transmitted in time slot n+1. In this case, the number of repeated transmission, denoted as NRD, is configured to be two. It should be noted that, if the NRD is configured to be a different value, e.g., three, then the DTU 432 may be transmitted three times. However, there may be delay of data. To prevent delay of data, each DTU may be reconfigured to include three user data codewords, which is then transmitted three times.

An alternative embodiment of a repeated transmission scheme 450 may be similar to the repeated transmission scheme 350. Specifically, each DTU may not be transmitted until all of its codeword spaces are filled or occupied by user data codewords. For example, in time slots n, n+1, and n+2, since data 1, 2, and 3 can not fully fill up any DTU, a DTU 452 fully occupied by previously arrived user data may be repeatedly transmitted (e.g., for four times from slots n−1 to n+2). Then, in time slot n+3, data 1, data 2, data 3, and data 4 have become available, which may fully fill up a DTU 454. Thus, the DTU 454 may be repeatedly transmitted for four times from slots n+3 to n+6, until a DTU 456 is formed in time slot n+7. The repeated transmission scheme 450 may be used when, for example, a user data rate of the subscriber line is not significantly lower than the connection rate. Otherwise, user data codewords may experience long delay in the TPS-TC module, e.g., if 20 time slots are needed before a DTU can be fully occupied by user data. To alleviate the potential delay problem, when user data rate is low, a DTU may be partially (instead of fully) filled before it is repeatedly transmitted.

Although embodiments 330, 350, 430, and 450 illustrate each generated DTU being repeatedly transmitted, in alternative embodiments, only a portion of generated DTUs may be repeatedly transmitted, while other DTUs may be transmitted only once. For example, if one DTU comprising user data becomes available in every time slot and NRD is not an integer (e.g., NRD=0.5), every other DTU may be repeatedly transmitted twice. Using the data arrival pattern shown in FIG. 4 as an example, the data may be transmitted in the following order (data representing a DTU): data 1, data 2, data 2, data 3, data 4, data 4, data 5, data 6, data 6, and so forth.

Although embodiments 330, 350, 430, and 450 illustrate repeated transmission of a DTU occurring continuously in consecutive time slots, in alternative embodiments, the DTU may be repeatedly transmitted in discontinuous or separated time slots. In the discontinuous TARTX mode, a distance between a repeated transmission and its preceding transmission may be greater than one time slot. Note that, in the continuous TARTX mode described with respect to embodiments 330, 350, 430, and 450, the distance between the repeated transmission and its preceding transmission may equal one time slot. A longer distance between each repeated transmission of the same DTU may help improve impulse noise protection that may last for a relatively long period. For example, if an impulse noise lasts longer than three time slots and the DTU is repeatedly transmitted three times in three consecutive time slots, all three times of transmission may be corrupted by the impulse noise. However, if repeated transmission of the DTU is implemented after the impulse noise is over, e.g., by creating a longer distance between transmissions of the same DTU, some transmissions may not be corrupted.

In an embodiment of the discontinuous TARTX mode, whether a certain DTU should be repeatedly transmitted and/or how many times it should be transmitted may depend on the number of user data codewords in the DTU. For example, if the DTU comprises a large number of user data codewords, it may be transmitted more times. Otherwise, if the DTU comprises a smaller number of user data codewords, it may be transmitted less times (e.g., one time).

In an embodiment of the discontinuous TARTX mode, using the data arrival pattern shown in FIG. 4 as an example, the data may be transmitted in the following order (data representing a DTU): data 1, data; data 2, data 1; data 3, data 2; data 4, data 3; data 5, data 4; data 6, data 5; and so forth. In this case, each DTU is repeatedly transmitted twice, with the distance between each transmission being three time slots.

In an alternative embodiment of the discontinuous TARTX mode, using the data arrival pattern shown in FIG. 4 as an example, the data may be transmitted in the following order (data representing a DTU): data 2, data 1, data; data 3, data 2, data 1; data 4, data 3, data 2; data 5, data 4, data 3; data 6, data 5, data 4; data 7, data 6, data 5; and so forth. In this case, each DTU is repeatedly transmitted three times, with the distance between each transmission being four time slots.

In an alternative embodiment of the discontinuous TARTX mode, using the data arrival pattern shown in FIG. 4 as an example, the data may be transmitted in the following order (data representing a DTU): data, data 1, data 2; data 1, data 2, data 3; data 2, data 3, data 4; data 3, data 4, data 5; data 4, data 5, data 6; data 5, data 6, data 7; and so forth. In this case, each DTU is repeatedly transmitted three times, with the distance between each transmission being four time slots. One skilled in the art will recognize that other variations of the discontinuous TARTX mode may be implemented similarly without departing from the scope of this disclosure.

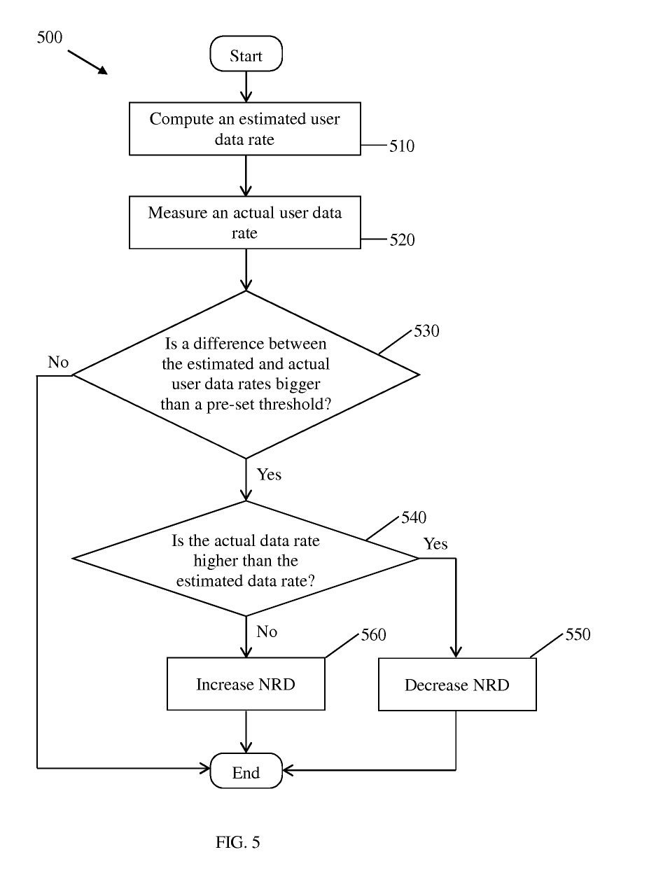

FIG. 5 illustrates an embodiment of a NRD updating method 500 implemented in a DSL apparatus (e.g., the reference model 200 in FIG. 2), which is coupled to a subscriber line. During system configuration or initiation stage, an initial value of NRD may be pre-set or pre-determined. During system operation, the NRD value may be updated periodically, a frequency of which may also be pre-set. For example, the NRD value may be pre-set to update once a second. The method 500 may be executed in each update of the NRD value. Specifically, the method 500 may start in step 510, where an estimated user data rate of the subscriber line may be computed over a period. In an embodiment, the estimation uses equation:

$$estimated user data rate = \frac{connection rate}{NRD} - overhead ,$$

where overhead comprises retransmission overhead and other overhead information, which contributes to the consumption of the connection rate.

In step 520, the actual user data rate of the subscriber line may be measured over the period. In an embodiment, if the user data rate varies in the period, the actual user data may be an average of user data rates over the period. In use, measurement of the user data rate may employ any suitable technique. In block 530, the method 500 may determine whether a difference between the actual data rate and the estimated data rate is larger than a threshold, a value of which may be pre-determined (e.g., zero or 0.05*(connection rate)). If the condition in the block 530 is met, the method 500 may proceed to block 540. Otherwise, the method 500 may end.

In block 540, the method 500 may further determine whether the actual data rate is higher than the estimated data rate. If the condition in the block 540 is met, the method 500 may proceed to step 550, in which the NRD value may be decreased. Otherwise, the method may proceed to step 560, in which the NRD value may be increased. In an embodiment, the extent to which the NRD value increase or decrease may be configured in a way such that, in a next update of the NRD, the difference between the actual user data rate and the estimated data rate may be no greater than the pre-set threshold.

FIG. 6 illustrates an embodiment of a repeated transmission method 600, which may be implemented in a DSL apparatus (e.g., the reference model 200 in FIG. 2). The method 600 may start in step 610, where a number of user data codewords or cells accumulated in a TPS-TC module may be counted or checked using, for example, a counter or register. Next, in block 620, the method 600 may determine whether any user data codeword/cell is available. If the condition in the block 620 is not met, the method 600 may proceed to step 630, where IDTU(s) or the previous DTU (if applicable) may be transmitted until user data codeword becomes available. Otherwise, the method 600 may proceed to step 640, where one or more user data codewords/cells may be obtained from the TPS-TC module, packed into a DTU, and repeatedly transmitted NRD times. In an embodiment, when obtaining user data from the TPS-TC module, a switch (e.g., the switch 234) coupling the TPS-TC module and a DTU framer may be closed. After obtaining user data from the TPS-TC module, the switch may be opened. Further, in each of the NRD transmissions, the DTU may comprise the same SID.

In step 650, one copy of the DTU may be added to or stored in a retransmission queue. In an embodiment, adding the DTU to the retransmission queue may occur when the DTU is transmitted for the first time. In an embodiment, when adding the DTU into the retransmission queue, a switch (e.g., the switch 240) coupling the retransmission queue and the DTU framer may be closed. After adding the DTU into the retransmission queue, the switch may be opened.

Implementation of TARTX schemes/methods disclosed herein may help reduce the need for retransmission (i.e., transmitting the DTU for an additional time after NRD transmissions). However, even though a DTU is repeatedly transmitted for a plurality of times, it is still possible that each time of transmission contains error or corruption, in which case the DTU may need to be transmitted an additional time. Therefore, embodiments of the present disclosure may be used in conjunction with a retransmission scheme. Either the transmitting side of the DTU or a corresponding receiving side of the DTU may be configured to make a decision of whether to retransmit.

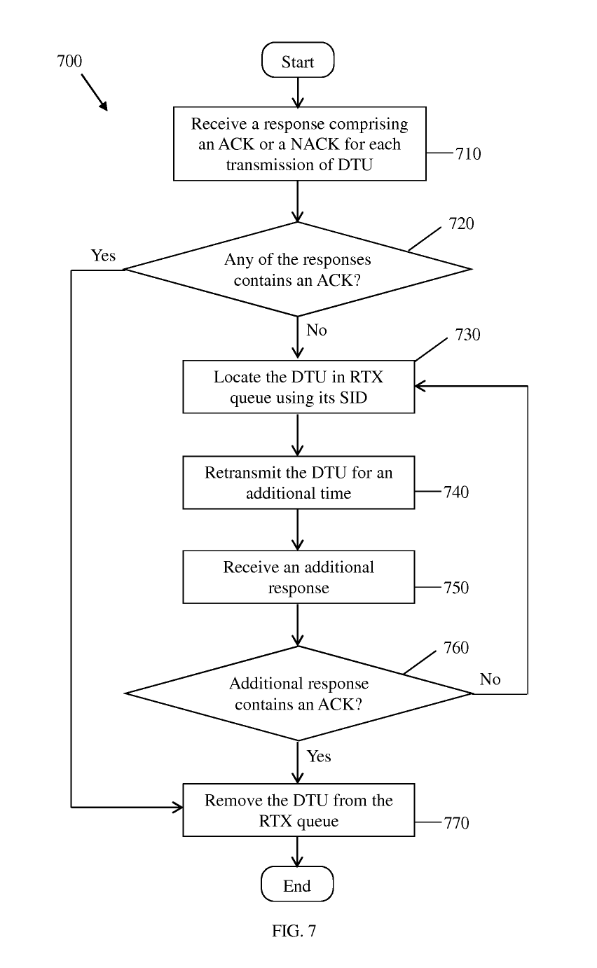

FIG. 7 illustrates an embodiment of a retransmission method 700, which may complement the method 600 to ensure that, after repeated transmissions of the DTU, at least one error-free copy is received by the corresponding receiver. The transmitting side may use the method 700 to determine whether a retransmission (after NRD transmissions of the DTU) is necessary. The method 700 may start in step 710, where the transmitting apparatus (e.g., the reference model 200) receives a response via the RRC channel for each transmission of the same DTU. For example, if the DTU is repeatedly transmitted for five (i.e., NRD=5) times in step 640 (shown in FIG. 6), the transmitting apparatus may receive five responses, each of which is sent back by the corresponding receiving side. Each response may comprise the SID of the DTU, and either an ACK or a NACK message.

In block 720, the method 700 may determine whether any of the responses comprises an ACK message. If the condition in the block 720 is not met, retransmission is required, thus the method 700 may proceed to step 730. Otherwise, retransmission is not required, and the method 700 may proceed to step 770. In step 730, the DTU may be located in the retransmission queue using its SID, which is contained in each received response. In step 740, the DTU, which has previously been transmitted NRD time, may be transmitted an additional time (i.e., retransmitted). In step 750, the transmitting apparatus may receive an additional response corresponding to the additional transmission. In block 760, the method 700 may determine whether the additional response contains an ACK message. If the condition in the block 760 is not met, another retransmission is required, thus the method 700 may return to step 730 to locate the DTU again in the retransmission queue. Otherwise, no more transmission is required, and the method 700 may proceed to step 770, where the DTU may be removed from the retransmission queue.

When the method 700 is implemented in the transmitting side, no change needs to be made in the corresponding receiving side to accommodate TARTX schemes disclosure herein. That is, the receiving side may use any response scheme including a conventional response scheme, in which the receiving side sends back a response message for each of the NRD copies of the DTU. Since only one error-free copy is necessary for the receiving side to interpret or decode user data contained in the DTU, the receiving side may employ any suitable scheme to pick one error-free copy and discard all other copies of the DTU.

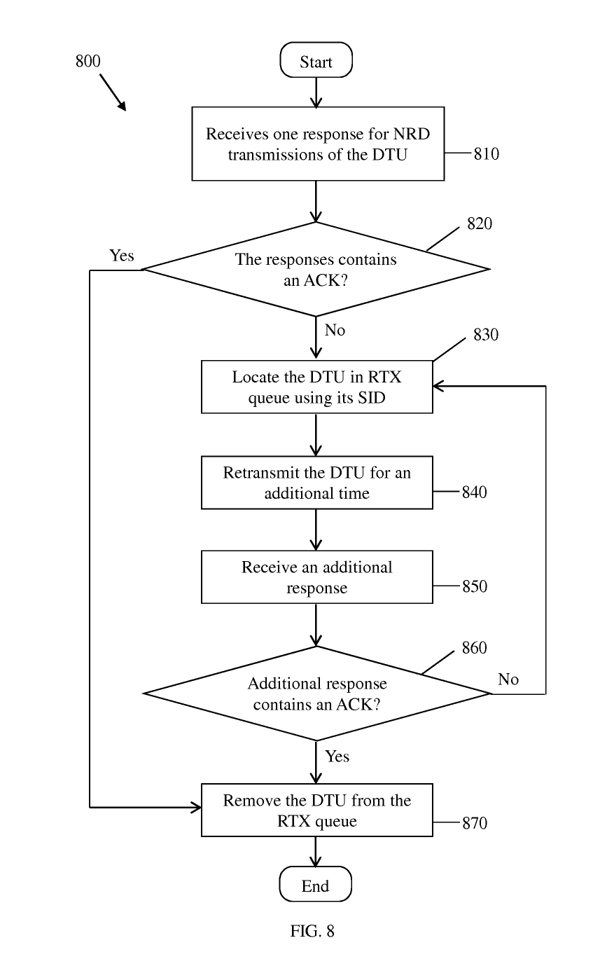

FIG. 8 illustrates an embodiment of a retransmission method 800, which may complement the method 600 to ensure that, after repeated transmissions of the DTU, at least one error-free copy is received by the corresponding receiver. When the method 800 is implemented in the transmitting side, the decision of whether to retransmit (after NRD transmissions of the DTU) is made by the corresponding receiving side. The method 800 may start in step 810, where the transmitting apparatus (e.g., the reference model 200) receives one response via the RRC channel for all NRD transmissions of the same DTU. For example, if the DTU is repeatedly transmitted for five (i.e., NRD=5) times in step 640, the transmitting apparatus may receive only one response, which is sent back by the corresponding receiving side. The response may comprise the SID of the DTU, and either an ACK or a NACK message.

In block 820, the method 800 may determine whether the response comprises an ACK message. If the condition in the block 820 is not met, retransmission is required, thus the method 800 may proceed to step 830. Otherwise, retransmission is not required, and the method 800 may proceed to step 850. In step 830, the DTU may be located in the retransmission queue using its SID, which is contained in the received response. In step 840, the DTU, which has previously been transmitted NRD time, may be transmitted an additional time (i.e., retransmitted). In step 850, the transmitting apparatus may receive an additional response corresponding to the additional transmission. In block 860, the method 800 may determine whether the additional response contains an ACK message. If the condition in the block 860 is not met, another retransmission is required, thus the method 800 may return to step 830 to locate the DTU again in the retransmission queue. Otherwise, no more transmission is required, and the method 800 may proceed to step 870, where the DTU may be removed from the retransmission queue.

When the method 800 is implemented in the transmitting side, the decision of whether to retransmit is made by the corresponding receiving side. In an embodiment of the receiving side, a variable denoted as LAST_SID (configured to store the SID of a last DTU of the repeatedly transmitted DTUs) may be reset or assigned an initial value. Further, a binary flag denoted as ERROR_FLAG (configured to indicate if there is an error) may be initially set to be false (i.e., ERROR_FLAG=false). Then, the following procedure may be implemented:

### 1. Receive a new DTU;

2. Check the received DTU to determine if there is an error in the DTU;
3. If there is no error in the DTU:
1) If the DTU SID=LAST_SID and ERROR_FLAG=false, discard the DTU and return to step 1; [Note 1]
2) Otherwise, if the DTU SID=LAST_SID and ERROR_FLAG=true, forward the DTU to TPS, set ERROR_FLAG=false, and return to step 1; [Note 2]
3) Otherwise, if the DTU ID LAST_SID, forward the DTU to TPS, set LAST_SID=DTU ID and ERROR_FLAG=false, and return to step 1; [Note 3]
Otherwise if there is an error in the DTU:
1) If the DTU SID=LAST_SID, discard the DTU, and return to step 1; [Note 4]
2) Otherwise if the DTU ID/LAST_SID, discard the DTU, set LAST_SID=DTU ID and ERROR_FLAG=true, and return to step 1; [Note 5] and
   4. Return to step 1.
   [Note 1] this DTU is not needed since an error-free DTU with the same SID has been received;
   [Note 2] this DTU is the first error-free DTU with this SID;
   [Note 3] this DTU is the first error-free DTU with a new SID;
   [Note 4] this DTU is discarded because it has error;
   [Note 5] this DTU is discarded and recorded as the first DTU with a new SID;

It should be noted that the methods illustrated herein may only include only a portion of necessary steps to ensure delivery of an error-free DTU from the transmitting side to the receiving side. Accordingly, other steps, such as the addition of overhead information, encoding/decoding user data and/or overhead, etc., may be incorporated into the methods wherever appropriate. Moreover, the execution order of steps may be flexibly changed, e.g., if a step does not depend on a preceding step. For example, in the NRD updating method 500, since estimation and measurement of user data rate do not depend on each other, these two steps may be executed concurrently or in any order.

Although some figures herein (e.g., embodiment 330 in FIG. 3) illustrates one DTU transmitted in each time slot, it should be understood that, in some embodiments, multiple DTUs may be simultaneously transmitted in the same time slot, and disclosed TARTX schemes may still be similarly implemented. For example, in the G.fast standard to be defined, time division duplexing (TDD) and hybrid automatic repeat request (HARQ) schemes may be employed. A plurality of DTUs, each comprising same or different user data, may be generated by a DSL apparatus (e.g., the reference model 200). One or more transmitters in the DSL apparatus may be configured to repeatedly transmit each of the plurality of DTUs. In an embodiment, a number of transmission times for each DTU may be equal. Further, each corresponding transmission (e.g., first time, second time, and so forth) of the plurality of DTUs may be performed simultaneously or concurrently, that is, in the same time slot.

In an embodiment, in case additional retransmission will be required for one or more of the plurality of DTUs transmitted, the DSL apparatus may further comprise a receiver configured to receive a response corresponding to each time of transmitting each of the plurality of DTUs. Each response comprises either an ACK or a NACK. After receiving the responses for all the transmitted DTUs, the transmitting side can identify which DTUs have been received by a corresponding receiving side without any error or corruption, and which DTUs still need to be retransmitted. In an embodiment, if no ACK is contained in any response corresponding to the one or more of the DTUs, the DSL apparatus may transmit the one or more of the DTUs an additional time.

Further, the repeated transmissions of the same DTU may allow the same information bits but different FEC. This may facilitate soft combining of DTUs at the receiver to recover DTUs with errors. For example, in a G.fast system, the disclosed TARTX scheme may be used with a Type I HARQ as well as a Type II HARQ, which is a chase combining scheme. The benefits of TARTX may include, but are not limited to, improving impulse noise protection and reduce delay of the retransmission time.

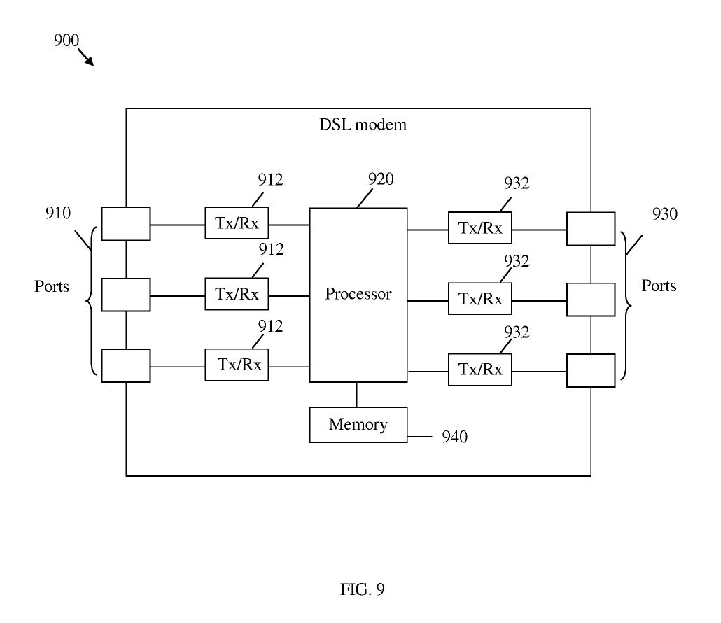

FIG. 9 illustrates an embodiment of a DSL modem 900, which may comprise, for example, a transceiver as described above, within a network or system. The DSL modem 900 may be located on an operator's end such as a CO, in which case each of a first plurality of ports 910 may be connected or coupled to a subscriber line. Alternatively, the DSL modem 900 may be located on a user's end such as a CPE, in which case there may be only one port 910 coupled to one subscriber line. A transmitter (Tx)/receiver (Rx) unit 912 may be coupled to each port 910 and configured to transmit data to or receive data from other DSL modems or network units. A logic unit or processor 920 coupled to the plurality of Tx/Rx units 912 may be configured to process data and determine which DSL modem or network unit to send the data to. The processor 920 may be implemented as one or more central processing unit (CPU) chips, cores (e.g., a multi-core processor), field-programmable gate arrays (FPGAs), application specific integrated circuits (ASICs), and/or digital signal processors (DSPs). A memory 940 may be coupled to the processor 920 and configured to store various types of data.

Since the DSL modem 900 may be an intermediary between two network units or sources, it may process and forward data from one source to another. Thus, the DSL modem 900 may further comprise a second plurality of ports 930 coupled to a second plurality of Tx/Rx units 932 for transmitting data to or receiving data from other network units. The processor 920 may be configured to implement any of the schemes/methods described herein, such as the repeated transmission schemes 330, 350, 430, and 450, the NRD updating method 500, the repeated transmission method 600, the retransmission method 700, and the retransmission method 800. Further, the DSL modem 900 may be configured to implement the reference model 200. For example, the TARTX control 242 may be implemented in the processor 920, the retransmission queue 238 may be implemented in the memory 940, and the PMD module 292 may be implemented in a Tx/Rx 912 or a Tx/Rx 932. The modules between the α₂ reference point and the δ reference point may be implemented in a Tx/Rx 912 or 932 or the processor 920 or the modules may be divided between the Tx/Rx 912 or 932 and the processor 920.

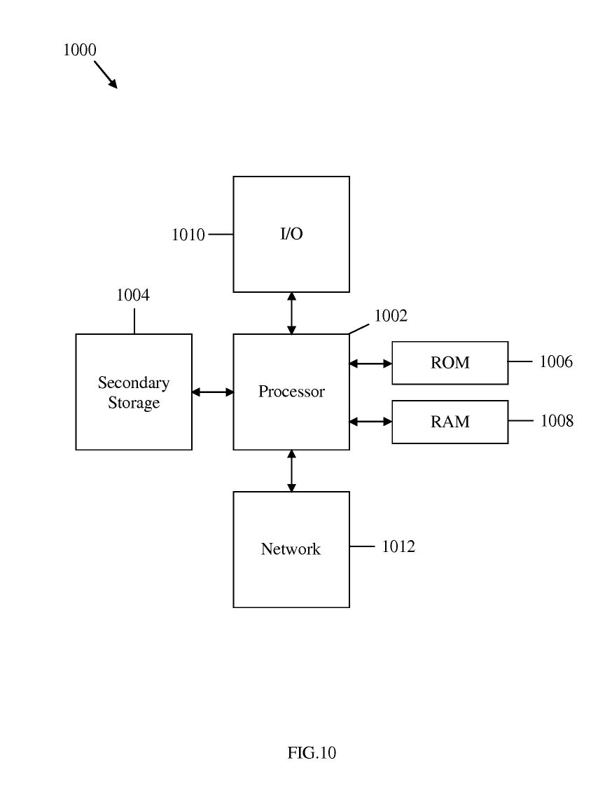

The schemes described above may be implemented on any general-purpose network component, such as a computer or network component with sufficient processing power, memory resources, and network throughput capability to handle the necessary workload placed upon it. FIG. 10 illustrates a schematic diagram of a general-purpose network component or computer system 1000 suitable for implementing one or more embodiments of the methods disclosed herein, such as the repeated transmission schemes 330, 350, 430, and 450, the NRD updating method 500, the repeated transmission method 600, the retransmission method 700, and the retransmission method 800. The general-purpose network component or computer system 1000 includes a processor 1002 (which may be referred to as a central processor unit or CPU) that is in communication with memory devices including secondary storage 1004, read only memory (ROM) 1006, random access memory (RAM) 1008, input/output (I/O) devices 1010, and network connectivity devices 1012. Although illustrated as a single processor, the processor 1002 is not so limited and may comprise multiple processors. The processor 1002 may be implemented as one or more CPU chips, cores (e.g., a multi-core processor), field-programmable gate arrays (FPGAs), application specific integrated circuits (ASICs), and/or digital signal processors (DSPs). The processor 1002 may be configured to implement any of the schemes described herein, including the repeated transmission schemes 330, 350, 430, and 450, the NRD updating method 500, the repeated transmission method 600, the retransmission method 700, and the retransmission method 800.

The secondary storage 1004 is typically comprised of one or more disk drives or tape drives and is used for non-volatile storage of data and as an over-flow data storage device if the RAM 1008 is not large enough to hold all working data. The secondary storage 1004 may be used to store programs that are loaded into the RAM 1008 when such programs are selected for execution. The ROM 1006 is used to store instructions and perhaps data that are read during program execution. The ROM 1006 is a non-volatile memory device that typically has a small memory capacity relative to the larger memory capacity of the secondary storage 1004. The RAM 1008 is used to store volatile data and perhaps to store instructions. Access to both the ROM 1006 and the RAM 1008 is typically faster than to the secondary storage 1004.

It is understood that by programming and/or loading executable instructions onto the DSL modem 900, at least one of the Tx/Rx 912 or 932, the processor 920, or the memory 940 are changed, transforming the DSL modem 900 in part into a particular machine or apparatus having the novel functionality taught by the present disclosure, such as the reference model apparatus 200. Similarly, it is understood that by programming and/or loading executable instructions onto the computer system 1000, at least one of the processor 1002, the ROM 1006, and the RAM 1008 are changed, transforming the communication device 1000 in part into a particular machine or apparatus having the novel functionality taught by the present disclosure, such as the reference model apparatus 200. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 70 percent, 71 percent, 72 percent, . . . , 95 percent, 96 percent, 97 percent, 98 percent, 99 percent, or 100 percent. Moreover, any numerical range defined by two R numbers as defined in the above is also specifically disclosed. The use of the term about means±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An apparatus used for digital subscriber line (DSL) communication comprising:
a processor configured to generate a data transmission unit (DTU) comprising user data; and
a transmitter configured to repeatedly transmit the DTU a plurality of times onto a subscriber line, wherein a number of the plurality of times is adaptively based on a user data rate of the subscriber line.

2. The apparatus of claim 1, wherein the DTU comprises a sequence identifier (SID), and wherein repeatedly transmitting the DTU uses the SID and occurs only when the user data rate is lower than a connection rate of the subscriber line.

3. The apparatus of claim 2, wherein the number of the plurality of times is updated periodically, and wherein a frequency of update is pre-determined.

4. The apparatus of claim 3, wherein updating the number of the plurality of times, denoted as NRD, comprises:
computing an estimated data rate of the subscriber line based on NRD;
measuring the user data rate; and
if the estimated data rate is higher than the user data rate by a threshold, increasing NRD;
otherwise if the estimated data rate is lower than the user data rate by the threshold, decreasing NRD.

5. The apparatus of claim 2, wherein the processor is further configured to enable a DTU framer to receive a new DTU from a transport protocol specific-transmission convergence (TPS-TC) module only after the plurality of transmissions.

6. The apparatus of claim 2, further comprising a memory coupled to the processor and configured to store one copy of the DTU.

7. The apparatus of claim 6, wherein the memory is coupled to the processor, and wherein the copy of the DTU is stored only when the DTU is transmitted for a first time of the plurality of times.

8. The apparatus of claim 6, further comprising a receiver configured to receive a response corresponding to each time of transmitting the DTU, wherein each response comprises an acknowledgement (ACK) or a negative acknowledgment (NACK), and wherein the transmitter is configured to transmit the DTU an additional time only if no ACK is contained in any response.

9. The apparatus of claim 6, further comprising a receiver configured to receive a response corresponding to the plurality of times of transmitting the DTU, and wherein the transmitter is further configured to transmit the DTU an additional time only if the response comprises a negative acknowledgment (NACK).

10. The apparatus of claim 2, wherein repeatedly transmitting the DTU occurs in consecutive time slots.

11. The apparatus of claim 2, wherein each of the repeated transmissions of the DTU is separated by at least one time slot.

12. The apparatus of claim 2, wherein the processor is further configured to generate a second DTU comprising user data, wherein the transmitter is further configured to transmit the second DTU only once onto the subscriber line, and wherein transmitting the second DTU immediately follows repeatedly transmitting the DTU.

13. The apparatus of claim 2, further comprising a receiver configured to receive the user data in at least two time slots, wherein the user data occupies at least two cells of the DTU.

14. The apparatus of claim 13, wherein the DTU does not contain any idle cell.

15. The apparatus of claim 2, further comprising a transport protocol specific-transmission convergence (TPS-TC) module configured to receive the user data and additional user data, wherein after the plurality of times of transmitting the DTU:
the processor is further configured to check whether any additional user data is available in the TPS-TC module;
the transmitter is further configured to transmit one or more idle DTUs if no additional user data is available.

16. The apparatus of claim 2, further comprising a transport protocol specific-transmission convergence (TPS-TC) module configured to receive the user data and additional user data, wherein after the plurality of times of transmitting the DTU:
the processor is further configured to check whether any additional user data is available in the TPS-TC module;
the transmitter is further configured to transmit the DTU more times if no additional user data is available.

17. The apparatus of claim 2, wherein the processor is further configured to generate a plurality of DTUs including the DTU, wherein the transmitter is further configured to repeatedly transmit each of the plurality of DTUs for an equal number of times, and wherein each corresponding transmission of the plurality of DTUs is performed simultaneously.

18. The apparatus of claim 17, further comprising a receiver configured to receive a response corresponding to each time of transmitting each of the plurality of DTUs, wherein each response comprises an acknowledgement (ACK) or a negative acknowledgment (NACK), and wherein the transmitter is configured to transmit one or more of the DTUs an additional time only if no ACK is contained in any response corresponding to the one or more of the DTUs.

19. A method of data communication comprising:
generating a data transmission unit (DTU) comprising user data; and
repeatedly transmitting the DTU a plurality of times onto a digital subscriber line (DSL), wherein a number of the plurality of times is adaptively based on a data rate of the subscriber line.

20. The method of claim 19, wherein the DTU comprises a sequence identifier (SID), and wherein repeatedly transmitting the DTU uses the SID and occurs only when the user data rate is lower than a connection rate of the subscriber line.

21. The method of claim 20, wherein the number of the plurality of times is updated periodically, and wherein a frequency of update is pre-determined.

22. The method of claim 21, wherein updating the number of the plurality of times, denoted as NRD, comprises:
computing an estimated data rate of the subscriber line based on NRD;
measuring the user data rate; and
if the estimated data rate is higher than the user data rate by a threshold, increasing NRD;
otherwise if the estimated data rate is lower than the user data rate by the threshold, decreasing NRD.

23. The method of claim 20, further comprising enabling a DTU framer to receive a new DTU from a transport protocol specific-transmission convergence (TPS-TC) module only after the plurality of transmissions.

24. The method of claim 20, further comprising storing only one copy of the DTU in a memory, wherein the memory is coupled to a processor in which the DTU is generated.

25. The method of claim 24, wherein the copy of the DTU is stored when the DTU is transmitted for a first time of the plurality of times.

26. The method of claim 20, further comprising:
receiving a response corresponding to each time of transmitting the DTU, wherein each response comprises an acknowledgement (ACK) or a negative acknowledgment (NACK); and
transmitting the DTU an additional time only if no ACK is contained in any response.

27. The method of claim 20, further comprising:
receiving one response corresponding to the plurality of times of transmitting the DTU; and
transmitting the DTU an additional time only if the response comprises a negative acknowledgment (NACK).

28. The method of claim 20, wherein repeatedly transmitting the DTU occurs in consecutive time slots.

29. The method of claim 20, wherein each of the repeated transmissions of the DTU is separated by at least one time slot.

30. The method of claim 20, further comprising:
generating a second DTU comprising user data; and
transmitting the second DTU only one time onto the subscriber line, wherein transmitting the second DTU immediately follows repeatedly transmitting the DTU.

31. The method of claim 20, further comprising receiving the user data in at least two time slots, wherein the user data occupies at least two cells of the DTU.

32. The method of claim 31, wherein the DTU does not contain any idle cell.

33. The method of claim 20, further comprising:
checking whether any additional user data is available in a transport protocol specific-transmission convergence (TPS-TC) module after the plurality of times of transmitting the DTU; and
transmitting one or more idle DTUs if no additional user data is available in the TPS-TC module.

34. The method of claim 20, further comprising:
checking whether any additional user data is available in a transport protocol specific-transmission convergence (TPS-TC) module after the plurality of times of transmitting the DTU; and
transmitting the DTU more times if no additional user data is available in the TPS-TC module.

35. The method of claim 20, further comprising:
generate a plurality of DTUs including the DTU; and
repeatedly transmitting each of the plurality of DTUs for an equal number of times, wherein each corresponding transmission of the plurality of DTUs occurs simultaneously.

36. The method of claim 35, further comprising:
receiving a response corresponding to each time of transmitting each of the plurality of DTUs, wherein each response comprises an acknowledgement (ACK) or a negative acknowledgment (NACK); and
transmitting one or more of the DTUs an additional time only if no ACK is contained in any response corresponding to the one or more of the DTUs.

37. An apparatus used in a digital subscriber line (DSL) system and configured to couple to a subscriber line, wherein the apparatus comprises:
a processor configured to:
generate a data transmission unit (DTU) comprising at least one user data codeword; and
determine a number of transmissions of the DTU based on a data rate of the subscriber line, wherein the number of transmissions is greater than one;
a transmitter configured to transmit the DTU for the number of transmissions; and
a receiver configured to receive a response corresponding to each time of transmitting the DTU, wherein each response comprises an acknowledgement (ACK) or a negative acknowledgment (NACK), and wherein the processor is further configured to instruct the transmitter to transmit the DTU an additional time only if all responses comprises NACKs.

38. The apparatus of claim 37, further comprising a memory coupled to the processor and configured to:
store one copy of the DTU during the repeated transmissions; and
remove the copy of the DTU if any of the response comprises an ACK.

39. The apparatus of claim 37, further comprising a memory coupled to the processor and configured to store one copy of the DTU during the repeated transmissions, wherein the DTU comprises a sequence identifier (SID), and wherein the additional time of transmitting the DTU involves locating the copy of the DTU in the memory using the SID.

40. The apparatus of claim 39, wherein the receiver is further configured to receive an additional response corresponding to the additional time of transmitting the DTU, and wherein the memory is further configured to remove the copy of the DTU if the additional response comprises an ACK.

41. The apparatus of claim 37, remotely coupled to a second apparatus via the subscriber line, wherein the second apparatus is configured to:
receive a plurality of copies of the DTU, each of which corresponding to one of the plurality of times transmitting the DTU;
generate and transmit the plurality of responses; and
keep only one of the plurality of copies of the DTU.
